(19) United States
(12) Patent Application Publication
(10) Pub. No.: US 2026/0022262 A1
(43) Pub. Date: Jan. 22, 2026

(54) Aqueous Ink Jet Ink Composition And Recording Method

(71) Applicant: SEIKO EPSON CORPORATION, Tokyo (JP)

(72) Inventors: Tetsuya AOYAMA, Shiojiri (JP); Kenta KIKUCHI, Suwa (JP); Yukimasa ISHIDA, Shiojiri (JP)

(21) Appl. No.: 19/273,217

(22) Filed: Jul. 18, 2025

(30) Foreign Application Priority Data
Jul. 19, 2024 (JP) 2024-115416

(51) Int. Cl. C09D 11/322; C09D 11/037; C09D 11/50; C09K 11/06

(52) U.S. Cl. CPC C09D 11/322; C09D 11/037; C09D 11/50; C09K 11/06; C09K 2211/1011

(57) ABSTRACT

Provided is an aqueous ink jet ink composition containing a coloring material and fulvic acid.

The present application is based on, and claims priority from JP Application Serial Number 2024-115416, filed Jul. 19, 2024, the disclosure of which is hereby incorporated by reference herein in its entirety.

### BACKGROUND

### 1. Technical Field

The present disclosure relates to an aqueous ink jet ink composition and a recording method.

### 2. Related Art

Ink jet recording methods can record high-definition images with a relatively simple apparatus and are being rapidly developed in various fields. In recent years, there has been a concern about environmental issues, and ink compositions have been developed in consideration of environmental issues by using materials derived from natural products. For example, JP-A-2014-185239 discloses, for the purpose of providing an ink jet ink composition containing a chelating agent having excellent biodegradability and having excellent ejection stability for a long term, an ink jet ink composition containing a predetermined chelating agent and water and having a pH (hydrogen ion index) of more than 7 and 10 or less.

The storage stability and the ejection stability of such an ink jet ink composition are required to be further improved.

### SUMMARY

An aqueous ink jet ink composition of the present disclosure contains a coloring material and fulvic acid.

A recording method of the present disclosure includes an attaching step of ejecting the aqueous ink jet ink composition from an ink jet head to attach the ink jet ink composition to a recording medium.

A recorded matter of the present disclosure is obtained by attaching the ink composition to a recording medium.

### BRIEF DESCRIPTION OF THE DRAWINGS

FIG. 1 is Table 1 showing the evaluation results of Examples.

FIG. 2 is Table 2 showing the evaluation results of Comparative Examples and Reference Example.

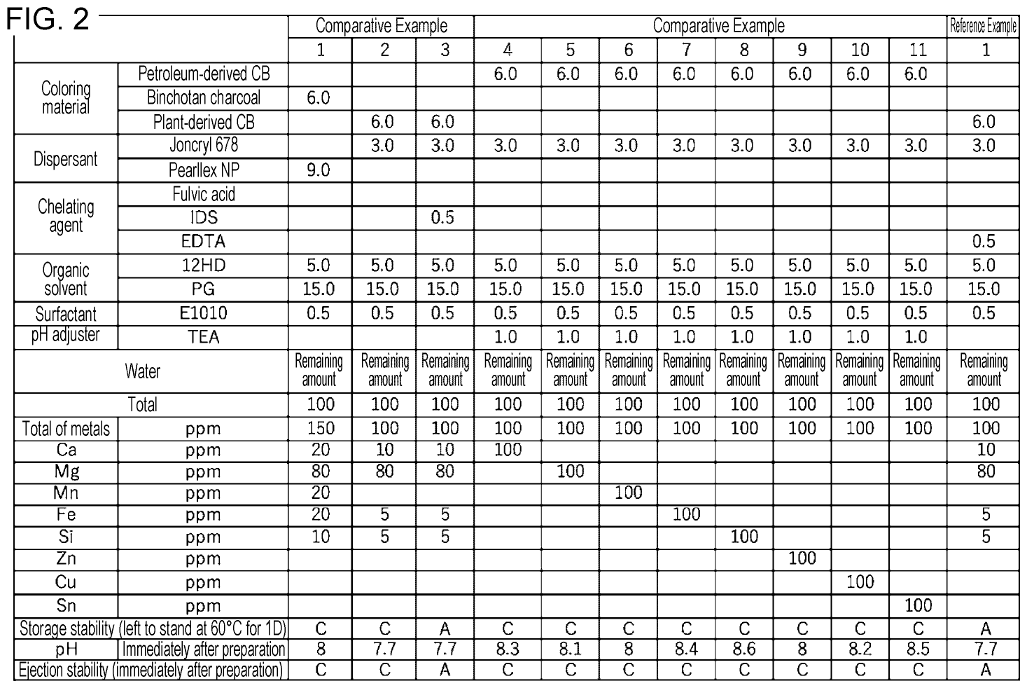

FIG. 3 is Table 3 showing the evaluation results of Example 9, Comparative Examples 2 and 3, and Reference Example 1.

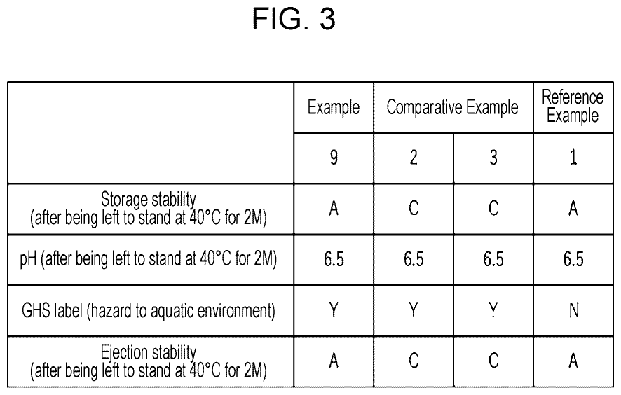

FIG. 4 is a diagram illustrating an example of a recording apparatus used in a recording method according to the present embodiment.

### DESCRIPTION OF EMBODIMENTS

An embodiment of the present disclosure (hereinafter referred to as “the present embodiment”) will be described below in detail with reference to the drawings as necessary, but the present disclosure is not limited thereto, and various modifications can be made without departing from the gist thereof. Note that in the drawings, the same elements are denoted by the same reference signs, and redundant descriptions will be omitted. In addition, positional relationships such as up, down, left, and right are based on the positional relationships shown in the drawings unless otherwise specified. Furthermore, the dimensional ratios in the drawings are not limited to the ratios shown in the drawings.

### 1. Ink Jet Ink Composition

The ink jet ink composition (hereinafter also simply referred to as “the ink composition”) according to the present embodiment contains a coloring material and fulvic acid.

The ink composition can contain metal ions mixed thereinto derived from the constituent materials of the ink composition or metal ions mixed thereinto from contact members with the ink composition, such as an ink composition container, and an ink composition flow path and a head of a printer. Such metal ions become a cause of generating insoluble salts or foreign substances in the ink composition and thus reduce the storage stability and the ejection stability of the ink composition. Thus, a chelating agent may be used in the ink composition in order to capture metal ions.

However, chelating agents such as EDTA have problems from the viewpoint of environmental protection because, for example, they are indicated to be harmful in the GHS classification or they are not decomposed by microorganisms or the like. In addition, a chelating agent synthesized from a petroleum-derived material has a problem in terms of environmental adaptability such as carbon dioxide reduction. In addition, IDS is known as a chelating agent that is decomposed by microorganisms, but it is difficult to form a complex in a low pH state, and the function of the chelating agent decreases. Therefore, there is also a problem that the storage stability and the ejection stability are inferior in an acidic condition.

Thus, in the present embodiment, fulvic acid is used as the chelating agent. Since fulvic acid is derived from plants and has no toxicity, it has high environmental adaptability. In addition, since fulvic acid has good water solubility in an acidic or basic environment and has low pH dependency of a chelating function, it is possible to trap metal ions in a wide range of pH environments, and it is possible to improve the storage stability and the ejection stability.

Components that can be contained in the ink composition according to the present embodiment and a production method thereof will be described below in detail.

### 1.1. Coloring Material

The coloring material is not particularly limited, and examples thereof include pigments and dyes. Among these, pigments are preferable. One kind of the coloring material may be used alone, or two or more kinds thereof may be used in combination.

The pigment is not particularly limited, and examples thereof include inorganic pigments such as carbon blacks (C.I. Pigment Black 7) such as furnace black, lamp black, acetylene black, and channel black, iron oxide, and titanium oxide; and organic pigments such as quinacridone-based pigments, quinacridonequinone-based pigments, dioxazine-based pigments, phthalocyanine-based pigments, anthrapyrimidine-based pigments, anthanthrone-based pigments, indanthrone-based pigments, flavanthrone-based pigments, perylene-based pigments, diketopyrrolopyrrole-based pigments, perinone-based pigments, quinophthalone-based pigments, anthraquinone-based pigments, thioindigo-based pigments, benzimidazolone-based pigments, isoindolinone-based pigments, azomethine-based pigments, and azo-based pigments.

In addition, the pigment may be, for example, a biomass-derived pigment such as plant charcoal obtained by carbonizing a plant, such as Binchotan charcoal, bamboo charcoal, activated charcoal, white charcoal, black charcoal, molded charcoal, oga charcoal, plum charcoal, activated charcoal, oak charcoal, Douglas-fir charcoal, seaweed charcoal, mangrove charcoal, or coconut shell charcoal; or vegetable oil charcoal (vegetable oil carbon black) obtained by carbonizing a vegetable oil.

In particular, the carbon black may include petroleum-derived carbon black, biomass-derived carbon black, and recycling-derived carbon black. Among these, the biomass-derived carbon black is preferable from the viewpoint of reducing petroleum-derived components, reducing carbon dioxide emissions due to petroleum-derived components, and enhancing environmental adaptability.

Among these, biomass-derived or recycling-derived pigments are preferable, and biomass-derived pigments are more preferable. The biomass-derived or recycling-derived pigments tend to contain metal ions as impurities due to their raw materials. Therefore, a chelating effect by fulvic acid for metal ions is easily obtained. In addition, when carbon black is used as the coloring material, the pH of the ink composition tends to decrease to acidify during long-term storage due to the influence of impurities, and this tendency is particularly remarkable in carbon black that is a biomass-derived or recycling-derived pigment. Thus, it is preferable to chelate using fulvic acid, the chelating function of which has low pH dependency. Further, the biomass-derived or recycling-derived pigment contains a large amount of impurities, and in addition, tends to have a large average particle size and a large particle size distribution, and thus the storage stability is likely to be impaired by metal ions. From this viewpoint also, it is preferable to improve the storage stability and the ejection stability by using fulvic acid.

In the present specification, the term “biomass-derived” refers to those produced from raw materials derived from organisms such as plants, animals, and microorganisms, rather than raw materials derived from fossil fuels such as petroleum and coal. In addition, recycling-derived is those produced from recycled raw materials, and examples thereof include carbon black obtained by thermally decomposing waste such as waste tires.

The pigment may be a self-dispersible pigment, which can be dispersed in an aqueous medium without a dispersant, or may be a resin-dispersed pigment, which is dispersed with a resin. Among these, the resin-dispersed pigment is preferable.

The self-dispersible pigment is a pigment that can be dispersed in an aqueous medium without a dispersant. Examples of such a self-dispersible pigment include a pigment in which a hydrophilic functional group or the like is directly introduced to the pigment surface by performing a physical or chemical surface treatment and that is dispersed in a solvent.

The resin-dispersed pigment is a pigment dispersed with a resin. The resin-dispersed pigment may be a pigment through a step of dispersing a coloring material with a resin dispersant, or a pigment dispersed through a step of encapsulating a coloring material by coating the surface of the coloring material with a resin.

The content of the coloring material is preferably 0.1 to 20% by mass, 1 to 15% by mass, 3 to 10% by mass, or 5 to 8% by mass with respect to the total amount of the ink composition. When the content of the coloring material is within the above range, the storage stability and the ejection stability tend to be further improved.

### 1.2. Dispersant

The dispersant is not particularly limited, and examples thereof include lignin sulfonate; poly (meth)acrylic acid, (meth)acrylic acid-acrylonitrile copolymers, (meth)acrylic acid-(meth)acrylate copolymers, vinyl acetate-(meth)acrylate copolymers, vinyl acetate-(meth)acrylic acid copolymers, (meth)acrylic resins such as vinylnaphthalene-(meth)acrylic acid copolymers, styrene-(meth)acrylic acid copolymers, styrene-(meth)acrylic acid-(meth)acrylate copolymers, styrene-α-methylstyrene-(meth)acrylic acid copolymers, acrylic resins that are styrene-α-methylstyrene-(meth)acrylic acid-(meth)acrylate copolymers and salts thereof; styrene-maleic acid copolymers, maleic acid-based resins that are styrene-maleic anhydride copolymers and the like and salts thereof; urethane-based resins that are polymer compounds containing a urethane bond formed by a reaction between an isocyanate group and a hydroxy group, may be linear and/or branched, and may or may not have a crosslinked structure and salts thereof; polyvinyl alcohols; vinylnaphthalene-maleic acid copolymers and salts thereof; vinyl acetate-maleate copolymers and salts thereof; and water-soluble resins such as vinyl acetate-crotonic acid copolymers and salts thereof. Among these, a copolymer of a monomer having a hydrophobic functional group and a monomer having a hydrophilic functional group, and a polymer including a monomer having both a hydrophobic functional group and a hydrophilic functional group are preferable. As the form of the copolymer, any form of a random copolymer, a block copolymer, an alternating copolymer, and a graft copolymer can be used.

Among these, lignin sulfonate and an acrylic resin dispersant are preferable. The acrylic resin is a resin using at least an acrylic monomer as described above. The acrylic resin using an acrylic monomer and a monomer other than the acrylic monomer may be used. Among the acrylic resin, an acrylic-vinyl resin is preferable.

By using such a dispersant, the storage stability and the ejection stability tend to be further improved.

Examples of the commercially available product of lignin sulfonate include Pearllex NP (manufactured by Nippon Paper Industries Co., Ltd.), Pearllex DP (manufactured by Nippon Paper Industries Co., Ltd.), Vanillex N (manufactured by Nippon Paper Industries Co., Ltd.), 471038-100G (manufactured by Sigma-Aldrich Co. LLC), New Kargen WG-4 (manufactured by Takemoto Oil & Fat Co., Ltd.), and San X P252 (manufactured by Nippon Paper Industries Co., Ltd.).

Examples of the commercially available product of the acrylic resin dispersant include X-200, X-1, X-205, X-220, and X-228 (manufactured by Seiko PMC Corporation), Nopcosperse (registered trademark) 6100 and 6110 (manufactured by San Nopco Ltd.), Joncryl 67, 586, 611, 678, 680, 682, and 819 (manufactured by BASF), Disperbyk-190 (manufactured by BYK Japan K. K.), and N-EA137, N-EA157, N-EA167, N-EA177, N-EA197D, N-EA207D, and E-EN10 (manufactured by DKS Co. Ltd.).

The content of the dispersant is preferably 1.0 to 15% by mass, 2.0 to 12% by mass, or 3.0 to 9.0% by mass with respect to the total amount of the ink composition. When the content of the dispersant is within the above range, the storage stability and the ejection stability tend to be further improved.

### 1.3. Fulvic Acid

The ink composition includes fulvic acid. Fulvic acid may be in the form of fulvate. When fulvic acid functions as a chelating agent and captures metal ions, the storage stability and the ejection stability tend to be further improved.

Fulvic acid is a general term for a group of acid type substances that are not precipitated by an acid among substances contained in corrosive substances. Fulvic acid can be obtained by separation and purification from soil using an acid or an alkali, and is also available as a commercial product. Fulvic acid is also produced in the process of subjecting carbon black to oxidation treatment such as self-dispersion. Since fulvic acid thus obtained has high water solubility and low pH dependency, it can maintain water solubility in a wide pH range and is less likely to become a foreign substance even when the pH changes. That is, even when a change in the state in the ink composition occurs, it can function usefully as a chelating agent. Therefore, the storage stability and the like are excellent.

In the present embodiment, separately prepared fulvic acid may be mixed to prepare a composition, or fulvic acid separated from a treated liquid secondarily produced during the oxidation treatment of the biomass-derived carbon black may be used after concentration, dilution, or the like.

Fulvic acid preferably has a peak at an emission wavelength (EM) of 380 to 600 nm and an excitation wavelength (EX) of 180 to 320 nm in an excitation-emission matrix analysis method, and more preferably has a peak at an emission wavelength (EM) of 400 to 600 nm and an excitation wavelength (EX) of 200 to 300 nm in the excitation-emission matrix analysis method. That is, fulvic acid preferably has a peak in the range of the excitation wavelength (EX) corresponding to the range of the emission wavelength (EM).

Fulvic acid produced when carbon black is subjected to oxidation treatment may have a peak of the emission wavelength and the excitation wavelength within the above ranges. Such fulvic acid has a carbon skeleton similar to that of the carbon black, has high affinity for the carbon black, easily exhibits a dispersion stabilizing effect, and thus the storage stability tends to be further improved.

The peak position of the emission wavelength of fulvic acid of the present embodiment in the excitation-emission matrix analysis method is preferably 400 to 550 nm, 400 to 500 nm, 420 to 480 nm, or 430 to 460 nm. When the emission wavelength of fulvic acid is within the above range, the storage stability tends to be further improved.

The peak position of the excitation wavelength of fulvic acid of the present embodiment in the excitation-emission matrix analysis method is preferably 200 to 320 nm, 200 to 300 nm, 220 to 280 nm, or 240 to 270 nm. When the excitation wavelength of fulvic acid is within the above range, the storage stability tends to be further improved.

The number of peaks with the emission wavelength and the excitation wavelength of fulvic acid in the excitation-emission matrix analysis method being in the above ranges may be one or more or 1 to 5, for example. Further, the number may be 2 or 3. When fulvic acid has a plurality of peaks, at least one of the peaks preferably satisfies the above wavelength regions. It is more preferable that all the peaks satisfy the above wavelength regions. That is, it is more preferable not to have a peak that does not satisfy the above wavelength regions.

A content B of fulvic acid is preferably 0.005 to 5.0% by mass, 0.001 to 4.0% by mass, 0.03 to 3.0% by mass, 0.05 to 2.0% by mass, or 0.10 to 1.0% by mass with respect to the total amount of the ink composition. When the content B of fulvic acid is within the above range, the storage stability tends to be further improved.

The mass ratio (B/A) of the content B of fulvic acid to a content A of the coloring material is preferably 0.0001 to 0.5, 0.001 to 0.4, 0.005 to 0.3, or 0.01 to 0.2. When the mass ratio of the content B of fulvic acid to the content A of the coloring material is within the above range, the storage stability tends to be further improved.

### 1.4. Metal Ion

As the content of the metal ions contained in the ink composition is smaller, a decrease in the storage stability and a decrease in the ejection stability due to the metal ions are further inhibited. From such a viewpoint, the total content of the metal ions of one or more elements selected from the group consisting of Ca, Mg, Al, Fe, Si, Zn, Cu, and Sn is preferably 140 ppm or less, 120 ppm or less, 100 ppm or less, or 80 ppm or less with respect to the total amount of the ink composition. In particular, the total content of divalent or higher metal ions is preferably 140 ppm or less, 120 ppm or less, 100 ppm or less, or 80 ppm or less with respect to the total amount of the ink composition. The total content of the metal ions of one or more elements selected from the group consisting of Ca, Mg, Al, Fe, Si, Zn, Cu, and Sn is 0 ppm or more, and preferably 1 ppm or more, 5 ppm or more, 10 ppm or more, or 15 ppm or more with respect to the total amount of the ink composition. Further, the content may be 30 ppm or more, or 50 ppm or more.

When the content of the metal ions is 140 ppm or less, the storage stability and the ejection stability tend to be further improved by the action of fulvic acid. In addition, when the content of the metal ions is 1 ppm or more, it is not necessary to excessively purify the ink composition or raw materials, the ink composition is more easily produced, and even when some metal ions are contained, fulvic acid tends to exhibit an effect of improving the storage stability and the ejection stability.

### 1.5. Organic Solvent

The ink composition may contain an organic solvent. Examples of the organic solvent include polyols and glycol ethers. Examples of the polyol include diethylene glycol, 1,2-hexanediol, propylene glycol, and glycerin. The glycol ether may be a monoether or diether of alkylene glycols, and examples thereof include ethy lene glycol monomethyl ether and triethylene glycol monobutyl ether. One kind of the organic solvent may be used alone, or two or more kinds thereof may be used in combination.

The content of the organic solvent is preferably 1% by mass or more with respect to the total amount of the ink composition. The content is more preferably 5 to 35% by mass, 10 to 30% by mass, or 15 to 25% by mass. When the content of the organic solvent is within the above range, the storage stability and the ejection stability tend to be further improved.

### 1.6. Surfactant

The ink composition may contain a surfactant. Examples of the surfactant include silicone-based surfactants, acetylene glycol-based surfactants, and fluorine-based surfactants. One kind of the surfactant may be used alone, or two or more kinds thereof may be used in combination.

The acetylene glycol-based surfactant is not particularly limited, and for example, one or more selected from 2, 4, 7, 9-tetramethyl-5-decyne-4, 7-diol and an alkyleneoxide adduct of 2,4, 7, 9-tetramethyl-5-decyne-4, 7-diol, and 2, 4-dimethyl-5-decyne-4-ol and an alkyleneoxide adduct of 2, 4-dimethyl-5-decyne-4-ol are preferable. The commercially available product of the acetylene glycol-based surfactant is not particularly limited, and examples thereof include the Olfine 104 series and the E series such as Olfine E1010 (trade names, manufactured by Air Products and Chemicals, Inc.), and Surfynol 61, 104, and 465 (trade names, manufactured by Nissin Chemical Co., Ltd.). Among these, Olfine E1010 is preferably contained as a surface tension adjuster from the viewpoint of more effectively and reliably exhibiting the effect of the present disclosure.

The content of the surfactant is preferably 0.01 to 1.5% by mass, 0.05 to 1% by mass, or 0.07 to 0.8% by mass with respect to the total amount of the ink composition. When the content of the surfactant is within the above range, the storage stability and the ejection stability tend to be further improved.

### 1.7. pH Adjuster

The ink composition may contain a pH adjuster as necessary. Examples of the pH adjuster include inorganic acids (e.g., sulfuric acid, hydrochloric acid, nitric acid, and the like), inorganic bases (e.g., lithium hydroxide, sodium hydroxide, potassium hydroxide, ammonia, and the like), organic acids (e.g., adipic acid, citric acid, succinic acid, and the like), and organic bases (triethanolamine, diethanolamine, monoethanolamine, triisopropanolamine, diisopropanolamine, and trishydroxymethylaminomethane). One kind of the pH adjuster may be used alone, or two or more kinds thereof may be used in combination.

The content of the pH adjuster is preferably 0.1 to 2.0% by mass, 0.3 to 1.5% by mass, or 0.5 to 1.2% by mass with respect to the total amount of the ink composition. When the content of the pH adjuster is within the above range, the chelating effect of fulvic acid is enhanced, and the storage stability and the ejection stability tend to be further improved.

### 1.8. Water

The content of water is preferably 50 to 95% by mass, 55 to 90% by mass, or 60 to 85% by mass with respect to the total amount of the ink composition. When the content of water is within the above range, the storage stability and the ejection stability tend to be excellent.

### 1.9. Other Components

The ink composition may contain components other than the components described above. As other components, a dissolution aid, a viscosity modifier, an antioxidant, a preservative, a fungicide, a corrosion inhibitor, and various additives can be added as appropriate.

1.10. pH

The pH of the ink composition of the present embodiment after being stored at 40° C. for 2 months is preferably 8 or less, 7 or less, less than 7, 6.7 or less, or 6.5 or less. The lower limit of the pH is preferably 4 or more, 5 or more, or 6 or more. The storage condition in which the ink composition is stored at 40° C. for 2 months is sufficiently assumed as a storage condition for a general ink composition, and even under the above acidic condition, fulvic acid effectively functions as a chelating agent in the ink composition of the present embodiment, and thus the storage stability and the ejection stability are excellent.

The pH of the ink composition of the present embodiment after being stored at 60° C. for 1 day is preferably 7 to 10.0, 7.5 to 9.0, or 8.0 to 8.5.

### 2. Recording Method

The recording method according to the present embodiment includes an attaching step of ejecting the ink jet ink composition from an ink jet head and attaching the ink jet ink composition to a recording medium. In addition, the recording method according to the present embodiment may further include a transporting step of transporting the recording medium, and the attaching step and the transporting step may be performed at the same time.

### 3. Recording Apparatus

The recording apparatus according to the present embodiment is a recording apparatus performing recording using the ink composition. The recording apparatus may be an ink jet recording apparatus performing recording by an ink jet method, which is preferable.

The ink jet recording apparatus of the embodiment includes the ink composition described above, and an ink jet head having a nozzle discharging the ink composition described above onto a recording medium, and preferably further includes a supply flow path circulating the ink composition described above and connected to the ink jet head, and a filter unit provided in the supply flow path of the ink jet head.

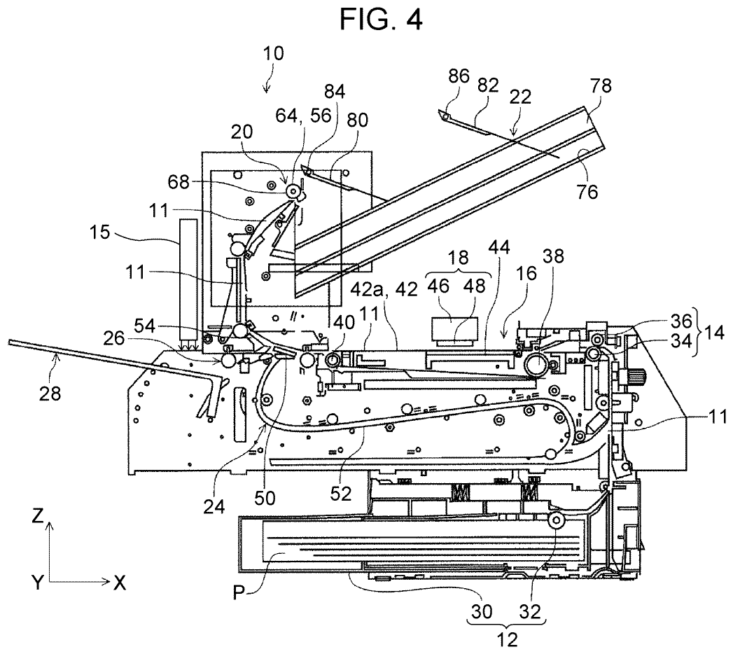

FIG. 4 illustrates an example of the ink jet recording apparatus as an example of a recording apparatus that can be used in the present embodiment. The ink jet recording apparatus according to the present embodiment will be described in more detail with reference to FIG. 4. In an X-Y-Z coordinate system illustrated in FIG. 4, the X direction indicates the length direction of a recording medium, the Y direction indicates the width direction of the recording medium in a transport path in the recording apparatus, and the Z direction indicates an apparatus height direction.

A recording apparatus 10 is, as an example, a line type ink jet printer capable of performing high-speed and high-density printing. The recording apparatus 10 includes a feeding section 12 storing a recording medium P such as paper, a transport section 14, a belt transport section 16, a recording section 8, a face-down (Fd) discharge section 20 as “discharge section,” a face-down (Fd) mounting section 22 as “mounting section,” an inverted path section 24 as “inverted transport mechanism,” a face-up (Fu) discharge section 26, and a face-up (Fu) mounting section 28.

The feeding section 12 is disposed in a lower portion of the recording apparatus 10. The feeding section 12 includes a feeding tray 30 storing the recording medium P and a feeding roller 32 feeding the recording medium P stored in the feeding tray 30 to the transport path 11.

The recording medium P stored in the feeding tray 30 is fed to the transport section 14 along the transport path 11 by the feeding roller 32. The transport section 14 includes a transport driving roller 34 and a transport driven roller 36. The transport driving roller 34 is rotationally driven by a drive source (not shown). In the transport section 14, the recording medium P is nipped between the transport driving roller 34 and the transport driven roller 36 and transported to the belt transport section 16 positioned on the downstream side in the transport path 11.

The belt transport section 16 includes a first roller 38 positioned on the upstream side in the transport path 11, a second roller 40 positioned on the downstream side, an endless belt 42 mounted on the first roller 38 and the second roller 40 in a rationally movable manner, and a support 44 supporting an upper section 42a of the endless belt 42 between the first roller 38 and the second roller 40.

The endless belt 42 is driven to move from the +X direction to the −X direction in the upper section 42a by the first roller 38 or the second roller 40 driven by a drive source (not shown). Therefore, the recording medium P transported from the transport section 14 is further transported to the downstream side in the transport path 11 in the belt transport section 16.

The recording section 8 includes a line type ink jet head 48 and a head holder 46 holding the ink jet head 48. The recording section 8 may be of a serial type one, in which an ink jet head is provided on a carriage reciprocating in the Y-axis direction. The ink jet head 48 is disposed so as to face the upper section 42a of the endless belt 42 supported by the support 44. When the recording media P is transported in the upper section 42a of the endless belt 42, the ink jet head 48 ejects the ink composition toward the recording media P to execute recording. The recording medium P is transported to the downstream side in the transport path 11 by the belt transport section 16 while recording is performed thereon.

A first branch section 50 is provided on the downstream side in the transport path 11 of the belt transport section 16. The first branch section 50 is configured to be switchable between the transport path 11 for transporting the recording medium P to the Fd discharge section 20 or the Fu discharge section 26 and an inverted path 52 of the inverted path section 24 for inverting the recording surface of the recording medium P to transport the recording medium P again to the recording section 8. The recording surface of the recording medium P, which is switched to the inverted path 52 by the first branch section 50 to be transported, is inverted in a transport process in the inverted path 52, and the recording medium P is transported again to the recording section 8 such that the surface opposite to the initial recording surface faces the ink jet head 48.

A second branch section 54 is further provided on the downstream side of the first branch section 50 along the transport path 11. The second branch section 54 is configured to be capable of switching the transport direction of the recording medium P so as to transport the recording medium P toward the Fd discharge section 20 or transport the recording medium P toward the Fu discharge section 26.

The recording medium P transported toward the Fd discharge section 20 in the second branch section 54 is discharged from the Fd discharge section 20 and mounted on the Fd mounting section 22. At this time, the recording medium P is mounted such that the recording surface thereof faces the Fd mounting section 22. Further, the recording medium P transported toward the Fu discharge section 26 in the second branch section 54 is discharged from the Fu discharge section 26 and mounted on the Fu mounting section 28. At this time, the recording medium P is mounted such that the recording surface thereof faces the side opposite to the Fu mounting section 28.

### 4. Recording Medium

The recording medium used in the present embodiment is not particularly limited, and examples thereof include an absorbent recording medium, a low-absorbent recording medium, and a non-absorbent recording medium, and the absorbent recording medium is preferable.

Examples of the absorbent recording medium include plain paper such as electrophotographic paper having high permeability of the ink composition, ink jet paper (ink jet dedicated paper including an ink composition absorbing layer formed of silica particles or alumina particles or an ink composition absorbing layer formed of a hydrophilic polymer such as polyvinyl alcohol (PVA) or polyvinylpyrrolidone (PVP)), corrugated cardboard, and fabrics such as cotton, silk, and mixed fabrics.

Examples of the low-absorbent recording medium include art paper, coated paper, and cast paper used for general offset printing in which the permeability of the ink composition is relatively low.

Examples of the non-absorbent recording medium include films and plates of plastics such as polyvinyl chloride, polyethylene, polypropylene, polyethylene terephthalate (PET), polycarbonate, polystyrene, and polyurethane; plates of metals such as iron, silver, copper, and aluminum; metal plates or plastic films produced by evaporation of these various metals, and plates of alloys such as stainless and brass; and recording media obtained by bonding (applying) a film of plastics such as polyvinyl chloride, polyethylene, polypropylene, polyethylene terephthalate (PET), polycarbonate, polystyrene, and polyurethane to a paper substrate.

### 5. Recorded Matter

The recorded matter of the present embodiment is obtained by attaching the ink composition described above to a recording medium. The recorded matter of the present embodiment using the ink composition described above can be recorded with an ink composition having excellent storage stability and ejection stability. In addition, by using an ink composition containing biomass-derived carbon black or carbon black derived from recycled raw materials, it is possible to perform recording with an ink composition having excellent storage stability and ejection stability while considering the environment.

### EXAMPLES

The present disclosure will be described below in more detail with reference to Examples and Comparative Examples. The present disclosure is not limited by the following Examples in any way.

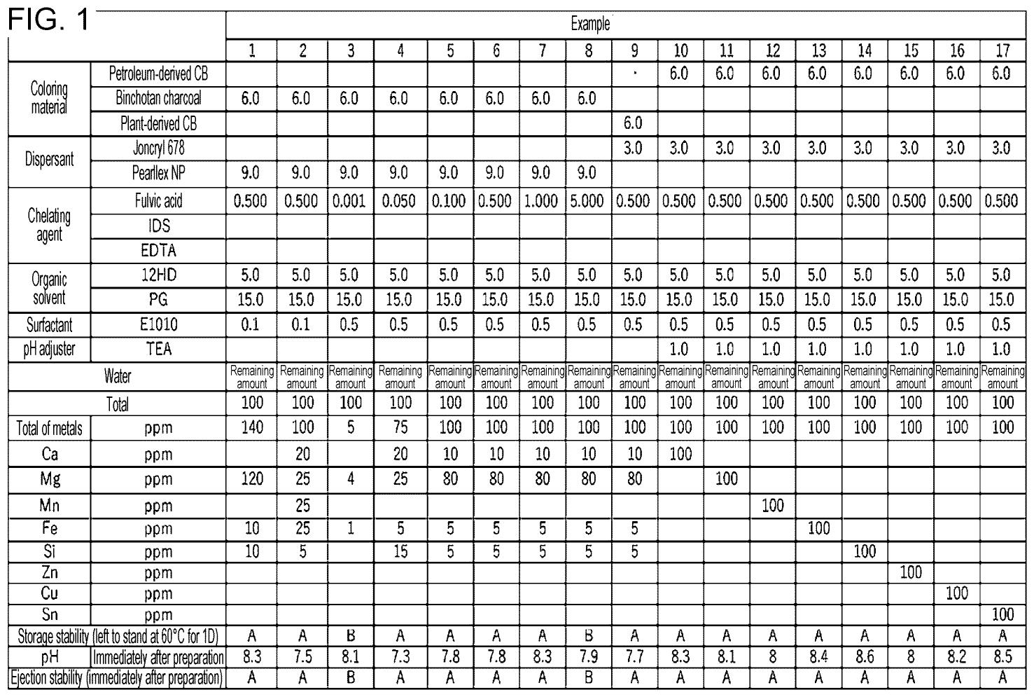

FIG. 1 describes Table 1 showing the compositions of the respective ink compositions of Examples and Comparative Examples and the evaluation results thereof.

### 1. Preparation of Ink Composition

A pigment and a dispersant are mixed in a mass ratio shown in Table 1 and Table 2, and the mixture is stirred in water to prepare a pigment dispersion liquid. Then, the obtained pigment dispersion liquid and the remaining components are mixed to obtain an ink composition. The numerical value of each component of each example shown in the tables represents % by mass unless otherwise specified. In addition, in the tables, each numerical value represents & by mass of the solid content of the component.

Further, in order to objectively judge a situation when a metal is present in the ink composition, the ink composition in a state in which a metal source is added is evaluated. Specifically, the following metal sources are added to the inks so as to have the compositions shown in Table 1 and Table 2. At this time, since the plant-derived CB contains a metal derived from a pigment, the amount of metal ions in the state of also containing the metal derived from the pigment is adjusted to the value shown in Table 1 and Table 2. If necessary, the pigment is also purified such that the amount of metal ions becomes the value shown in Table 1 and Table 2.

Details of the product components used in Table 1 and Table 2 are as follows.

### Coloring Material

Petroleum-derived CB (Aqua-Black 162, manufactured by Tokai Carbon Co., Ltd.)
Binchotan charcoal (manufactured by Kiriya Chemical Co. Ltd.)
Plant-derived CB (vegetable oil-based, manufactured by Orion Engineered Carbons S.A.)

### Dispersant

Joncryl 678 (styrene-acrylic resin, manufactured by BASF)
Pearllex NP (sodium lignosulfonate, manufactured by Nippon Paper Industries Co., Ltd.)

### Chelating Agent

Fulvic acid (see Preparation Example 1 below)
IDS (tetrasodium iminodisuccinate)
EDTA (disodium ethylenediaminetetraacetate dihydrate)

### Organic Solvent

12HD (1,2-hexanediol)
PG (propylene glycol)

### Surfactant

E1010 (manufactured by Nissin Chemical Co., Ltd., Olfine E1010)

### pH Adjuster

TEA (triethanolamine)

### Metal Source

Ca source: calcium carbonate solution
Zn source: zinc stearate solution
Mg source: magnesium stearate solution
Fe source: iron carbonate solution
Al source: aluminum hydroxide
Cu source: copper hydroxide solution
Sn source: tin hydroxide solution
Si source: 0.1% silica solution (NaOH solution)

### 1.1. Preparation Example 1 (Preparation Example of Fulvic Acid)

Carbon black (PRINTEX Nature, manufactured by Orion Engineered Carbons S.A., plant oil carbon black) in an amount of 25 g is stirred and washed with toluene to wash off substances such as unburned components adhering to the surface of the carbon black. Sodium hypochlorite in an amount of 5 g is added to the carbon black after the washing step in water to perform an oxidation treatment. After the treatment, the carbon black is removed by centrifugation, the waste liquid is recovered, an alkali aqueous solution is added to the waste liquid to separate the generated insoluble matter (humus) and the liquid from each other, an acid aqueous solution is further added to the liquid remaining after the removal of the insoluble matter, the generated insoluble matter is separated, and the remaining liquid is concentrated and purified to obtain fulvic acid.

### 1.2. Excitation-Emission Matrix Analysis Method (EEM)

The carbon black dispersion liquid prepared as described above is subjected to a centrifugal separator (high-speed cooling centrifuge Suprema 21, manufactured by Tomy Seiko Co., Ltd.), and the carbon black is precipitated under separation conditions of 20° C., 12,000 rpm, and 120 min. When fine particles remain in the supernatant, magnesium sulfate is added in an amount of 0.1% to 0.5% with respect to the charged carbon black to aggregate the particles, and the particles are again precipitated by the centrifugal separator. Then, the carbon black is removed, and the supernatant is used as a measurement sample.

The obtained measurement sample is diluted 1,000 times with pure water, and the excitation wavelength (Ex) is three dimensionally measured by a lateral reflection method under the following conditions. When the prepared measurement sample is dense, a surface reflection method can also be selected.
Holder: a holder for liquids (a lateral photometric system) or a holder for solids (a surface photometric system) Cell: a surface-polished quartz cell (a 10×10 mm square quartz cell, lateral photometry) or a two-sided polished quartz cell (a 20×10 mm quartz cell, surface photometry).
Measurement wavelength for excitation (Ex): 200 to 700 nm
Measurement wavelength for emission (Em): 200 to 700 nm
Data interval for excitation (Ex): 5.0 nm
Data interval for emission (Em): 5.0 nm
Scan speed: 60,000 nm/min
Slit width for excitation (Ex): 5.0 nm
Slit width for emission (Em): 5.0 nm
Sensitivity: a photomultiplier voltage of 700 V
Response: 2 ms
Automatic filter control: ON (automatic high-order light cutting)

As a measurement result of the excitation-emission matrix analysis method, fulvic acid obtained in Preparation Example 1 above has two peaks of a peak at an excitation wavelength of 260 nm and an emission wavelength of 445 nm and a peak at an excitation wavelength of 265 nm and an emission wavelength of 430 nm.

### 1.3. Mass Spectrometry of Metal Components

The mass spectrometry of the metal components in the ink composition was measured with ICP-OES (G8015AA, manufactured by Agilent Technologies).

1.4. pH

The prepared ink composition is stored at 60° C. for 1 day, and then the pH is measured with a glass electrode pH meter (manufactured by YOKOGAWA, product name: MODEL PH82). Note that there is no significant change from the pH measured immediately after production, and there is no change or a change of less than 1.

### 2. Evaluation Method

### 2.1. Storage Stability (60° C., 1 Day)

The ink composition is put in a polyethylene pack, left to stand at 60° C. for 1 day, and then left to cool at 25° C. for 1 day. The ink composition after being left to cool is taken out and allowed to pass through a filter having a diameter of 10 μm, and the filter residue is checked to evaluate the storage stability according to the following evaluation criteria. It is visually observed with a microscope at 300×.

### Evaluation Criteria

A: The number of foreign substances is less than 10.
B: The number of foreign substances is 10 or more and less than 50.
C: The number of foreign substances is 50 or more.

### 2.2. Ejection Stability (60° C., 1 Day)

The ink composition after being stored at 60° C. for 1 day is charged into a predetermined ink composition storage vessel, the storage vessel is mounted on a recording apparatus (a modified machine of PX-H6000, manufactured by Seiko Epson Corporation), the ink jet ink composition is ejected, a solid pattern is printed on a recording medium (Xerox P paper) with a recording resolution of 1,440× 720 dpi, the ejection state after printing is checked, and the ejection stability is evaluated according to the following evaluation criteria. The operating environment of the recording apparatus (printer) is set to 40° C. and 20% RH.

### Evaluation Criteria

A: The number of non-ejecting nozzles is 3% or less.
B: The number of non-ejecting nozzles is more than 3% and 7% or less.
C: The number of non-ejecting nozzles is more than 7%.
   2.3. Storage Stability (after being left to stand at 40° C. for 2 months)

The storage stability of Example 9, Comparative Examples 2 and 3, and Reference Example 1 is evaluated in the same manner as described above except that the storage conditions are set to 40° C. for 2 months. The pH of the ink composition at this time (after being left to stand at 40° C. for 2 months) is measured with a glass electrode pH meter.

### Evaluation Criteria

A: The number of foreign substances is less than 10.
B: The number of foreign substances is 10 or more and less than 50.
C: The number of foreign substances is 50 or more.
   2.4. Ejection Stability (after being Left to Stand at 40° C. For 2 Months)

The ejection stability of Example 9, Comparative Examples 2 and 3, and Reference Example 1 is evaluated in the same manner as in the above evaluation of the ejection stability except that the ink after being stored at 40° C. for 2 months is used.

### Evaluation Criteria

A: The number of non-ejecting nozzles is 3% or less.
B: The number of non-ejecting nozzles is more than 3% and 7% or less.
C: The number of non-ejecting nozzles is more than 7%.

### 2.5. GHS Classification

Example 9, Comparative Examples 2 and 3, and Reference Example 1 are evaluated as to whether the components contained in the ink are applicable to Category 3 of Hazard to the aquatic environment in the Global Harmonization System (GHS) about the classification and labeling of chemical products.

### Evaluation Criteria

Y: not applicable
N: applicable

### 3. Evaluation Results

Table 1 and Table 2 show the evaluation results of the ink compositions used in the respective examples. It is found from Table 1 that the aqueous ink jet ink composition containing the coloring material and fulvic acid has excellent storage stability and ejection stability. In addition, as shown in Table 3, it is found that the aqueous ink jet ink composition of the present disclosure has high environmental adaptability, and has excellent storage stability and ejection stability even when stored for a long period of time.

What is claimed is:

1. An aqueous ink jet ink composition comprising:
a coloring material; and
fulvic acid.

2. The aqueous ink jet ink composition according to claim 1, wherein a content of the fulvic acid is 0.001 to 1.0% by mass with respect to a total amount of the ink jet ink composition.

3. The aqueous ink jet ink composition according to claim 1, wherein the fulvic acid has a peak at an emission wavelength of 400 nm to 600 nm and an excitation wavelength (EX) of 200 nm to 300 nm in an excitation-emission matrix analysis method.

4. The aqueous ink jet ink composition according to claim 1, wherein a total content of metal ions of one or more elements selected from the group consisting of Ca, Mg, Al, Fe, Si, Zn, Cu, and Sn is 140 ppm or less with respect to a total amount of the ink jet ink composition.

5. The aqueous ink jet ink composition according to claim 1, having a pH after storage at 40° C. for 2 months of less than 7.

6. The aqueous ink jet ink composition according to claim 1, wherein a pigment is contained as the coloring material.

7. The aqueous ink jet ink composition according to claim 1, wherein petroleum-derived carbon black or biomass-derived carbon black is contained as the coloring material.

8. The aqueous ink jet ink composition according to claim 1, wherein a pigment dispersed with a resin is contained as the coloring material.

9. A recording method comprising an attaching step of ejecting the aqueous ink jet ink composition according to claim 1 from an ink jet head to attach the ink jet ink composition to a recording medium.
